(19) United States
(12) Patent Application Publication
(10) Pub. No.: US 2005/0283399 A1
(43) Pub. Date: Dec. 22, 2005

(54) Method for operating a catering business

(76) Inventor: Anthony A. Aquilante, Phoenixville, PA (US)

Correspondence Address: RATNERPRESTIA, P O BOX 980, VALLEY FORGE, PA, 19482-0980, US

(21) Appl. No.: 10/872,719

(22) Filed: Jun. 21, 2004

(51) Int. Cl. G06F 17/60

(52) U.S. Cl. 705/14

(57) ABSTRACT

A method of promoting an off-premise catering business includes establishing a relationship between a supermarket and an off-premise caterer. The method also includes providing a location in the supermarket for a customer of the supermarket to provide information related to an event. Further, the method includes determining, using predetermined criteria, if off-premise catering is appropriate for the event. Further still, the method includes opening communication between the customer and the off-premise caterer if it is determined that off-premise catering is appropriate for the event.

### FIELD OF THE INVENTION

The present invention relates to the operation of a catering business, and more particularly, to the operation of an off-premise catering business in conjunction with a supermarket.

### BACKGROUND OF THE INVENTION

In recent years, competition among supermarkets has resulted in various attempts by certain supermarkets to distinguish themselves from other supermarkets. For example, certain supermarkets sell party trays and other items for pick-up by customers. Such party trays may include items such as deli meats, cheeses, salads, fruits, vegetables, and condiments. Certain supermarkets also offer specialty prepared foods to customers. For example, such specialty prepared foods include prepared meats and entrees, prepared soups, prepared side dishes, prepared salads, specialty ethnic foods, as well as a number of other specialty prepared foods.

By offering such party trays and specialty prepared foods, certain supermarkets may attract customers who appreciate the convenience of such items; however, the use of these items is typically limited to certain types of events. For example, such events are typically limited to a relatively small number of guests, and require little or no assistance from the supermarket other than providing the food items for pick-up by the customer. Such food items are typically not useful for larger events which may involve other catering services.

Thus, when an event involves a relatively large number of guests, or utilizes catering services that the supermarkets cannot (or do not) provide, customers typically utilize an off-premise caterer. Such off-premise caterers often have expertise in a variety of subjects related to catering an event. Such expertise may relate to, for example, food delivery (e.g., heated transportation, refrigerated transportation, etc.), food set-up (e.g., serving dishes, utensils, plates, etc.), event furniture (e.g., tables, chairs, etc.), entertainment options, facilities, etc. While off-premise caterers are often equipped to service a wide range of events, competition among such caterers limits their profit margin, which in turn limits their ability to dedicate significant funds to advertising.

Thus, it would be desirable to provide a method of utilizing the benefits of supermarkets (e.g., heavy customer traffic, prepared foods, etc.) in connection with an off-premise catering business which can service larger events, and provide a desired level of catering expertise to customers.

### SUMMARY OF THE INVENTION

To overcome the shortcomings of conventional methods, a new method of promoting an off-premise catering business is provided. According to an exemplary embodiment of the present invention, the method includes establishing a relationship between a supermarket and an off-premise caterer. The method also includes providing a location in the supermarket for a customer of the supermarket to provide information related to an event. Further, the method includes determining, using predetermined criteria, if off-premise catering is appropriate for the event. Further still, the method includes opening communication between the customer and the off-premise caterer if it is determined that off-premise catering is appropriate for the event.

According to another exemplary embodiment of the present invention, a method of establishing a relationship between a supermarket and an off-premise caterer is provided. The method includes locating a plurality of caterers within a predetermined geographic area, the geographic area being predetermined at least partially based on a location of the supermarket. The method also includes selecting one of the plurality of caterers to provide off-premise catering services to customers of the supermarket. Further, the method includes defining, for use by the supermarket, predetermined criteria for determining if off-premise catering is appropriate for an event. Further still, the method includes determining paths of communication for use between a customer of the supermarket and the selected caterer if the supermarket determines that off-premise catering is appropriate for the event.

### BRIEF DESCRIPTION OF THE DRAWINGS

Exemplary embodiments of the invention will be described with reference to the drawings, of which:

FIG. 1 is a block diagram of a supermarket useful in describing an exemplary embodiment of the present invention;

FIG. 2 is a block diagram of a location in a supermarket useful in describing an exemplary embodiment of the present invention;

FIG. 3 is another location in a supermarket useful in describing an exemplary embodiment of the present invention;

FIG. 4 is a flow diagram illustrating a method of determining if off-premise catering is appropriate for an event in accordance with an exemplary embodiment of the present invention;

FIG. 5A is a catering questionnaire used in accordance with an exemplary embodiment of the present invention;

FIG. 5B is another catering questionnaire used in accordance with an exemplary embodiment of the present invention;

FIG. 6 is an illustration of a form used by a caterer in accordance with an exemplary embodiment of the present invention;

FIG. 7 is a flow diagram illustrating a method of promoting an off-premise catering business in accordance with an exemplary embodiment of the present invention; and

FIG. 8 is a flow diagram illustrating a method of establishing a relationship between a supermarket and an off-premise caterer in accordance with an exemplary embodiment of the present invention.

### DETAILED DESCRIPTION OF THE INVENTION

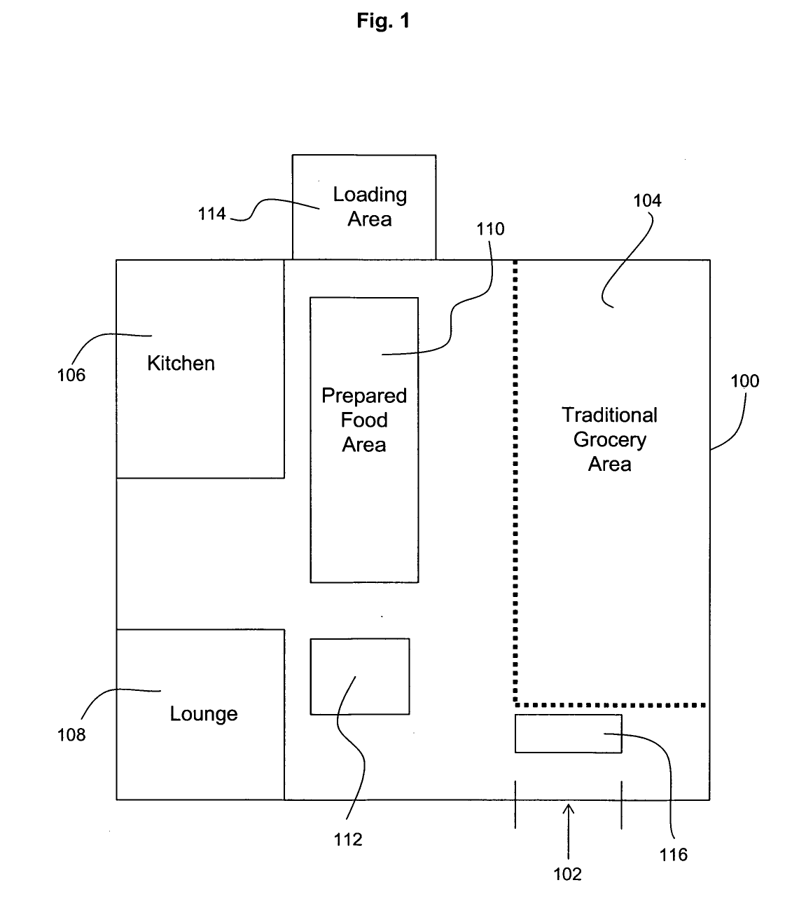

FIG. 1 is a block diagram of supermarket 100. Customers enter supermarket 100 through main entrance 102. As customers enter supermarket 100 through main entrance 102, they may view advertisement 116 (e.g., a sign or the like) which advertises off-premise catering services available to customers of the supermarket. Although advertisement 116 is illustrated in close proximity to main entrance 102, advertisement 116 could be provided in a number of locations, for example, near prepared foods sold by supermarket 100. Supermarket 100 includes traditional grocery area 104 which may be arranged as a conventional supermarket having aisles of dried goods, refrigerated items, etc.

Supermarket 100 also includes kitchen 106 which may be used to prepare food items used in connection with an off-premise caterer as will be described herein. Adjacent kitchen 106 is lounge 108 where customers of supermarket 100 may relax while shopping. Further, lounge 108 may be used in connection with planning a catered event. For example, a customer may meet with an employee of supermarket 100 (or an off-premise caterer used by supermarket 100) in lounge 108 to discuss catering options in a desirable and relaxed environment. Food items prepared in kitchen 106 may be displayed for sale in prepared food area 110. As provided above, such prepared food items, which may become familiar to customers of supermarket 100, are available for use through an off-premise caterer as will be described further herein.

As opposed to conventional prepared food items sold in a supermarket (e.g., deli sandwiches, salad bar items, etc.), prepared food area 110 may include a number of specialty items. For example, prepared food area 110 may include a pasta station, a Chinese food station, a Mexican food station, a seafood station, a kosher food station, a meat/poultry station, etc. Each of these stations may include a number of specialty prepared food items. When customers of supermarket 100 shop, they may occasionally “pick-up” certain items from prepared food area 110, thereby becoming familiar with these items. Because certain of these food items are “specialty” items, a customer may develop a particular taste for such items. In such a circumstance, the customer may be inclined to use an off-premise caterer associated with the supermarket, where the customer can select the familiar food items sold by the supermarket to be served in connection with an event. This situation desirably adds a level of price and quality predictability to food items served at a catered event.

Supermarket 100 also includes location 112 through which a customer of supermarket 100 may provide information related to a potential catered event. For example, an employee of supermarket 100 may be stationed at location 112 to discuss catering options with the customer. Alternatively, a computer (e.g., a touch screen computer) may be provided at location 112 through which a customer may enter information related to the event.

As illustrated in FIG. 1, supermarket 100 also includes loading area 114. Loading area 114 may be used in conjunction with the present invention in that an off-premise caterer associated with supermarket 100 may pick up certain items (e.g., prepared foods, etc.) from supermarket 100 for use in an event at loading area 114.

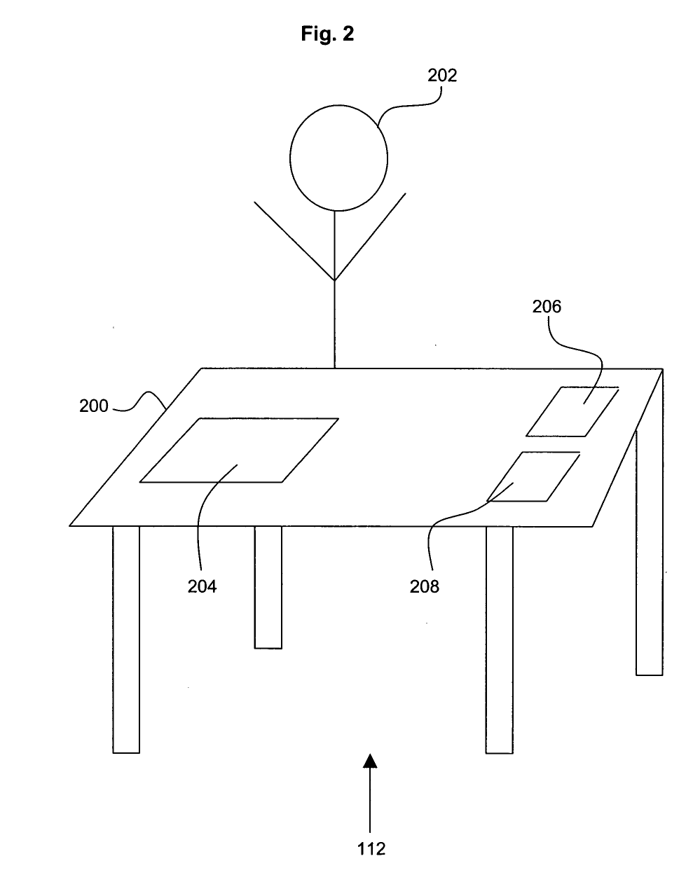

FIG. 2 is a block diagram illustration of location 112 in an embodiment of the present invention where an employee of supermarket 100 (e.g., a catering coordinator) is stationed at location 112. In the exemplary embodiment of the present invention illustrated in FIG. 2, employee 202 is stationed at desk 200 to answer questions related to catering an event. Alternatively, employee 202 may be stationed at a podium, desk, or any other appropriate station.

Station 112 includes various pieces of electronic equipment through which employee 202 may communicate, regarding catering events, with an off-premise caterer. Such electronic equipment includes, for example, computer 204, phone 206, and fax machine 208.

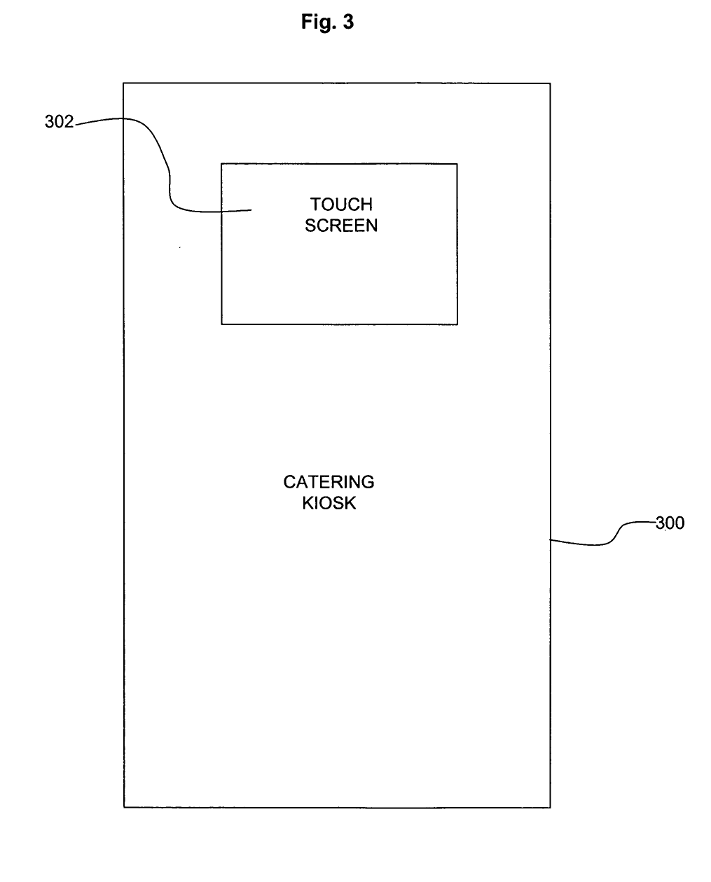

In addition to location 112 (or as an alternative to location 112), catering kiosk 300 may be provided as illustrated in FIG. 3. Essentially, catering kiosk 300 is a computer through which a customer may input certain data (e.g., name, address, phone number, type of event, estimated number of guests, etc.) for use by supermarket 100 in relation to the event. In the exemplary embodiment of the present invention illustrated in FIG. 3, catering kiosk includes touch screen 302 through which the customer enters such data. Of course, a conventional keyboard may be provided in addition to (or as an alternative to) touch screen 302.

Referring again to FIG. 1, a customer entering supermarket 100 through main entrance 102 may proceed to location 112 in order to discuss (e.g., with a catering coordinator) having an event catered through supermarket 100. The catering coordinator may provide assistance to the customer in determining if off-premise catering is appropriate for the event, or if conventional party pick-up service (e.g., party trays, etc.) is more appropriate.

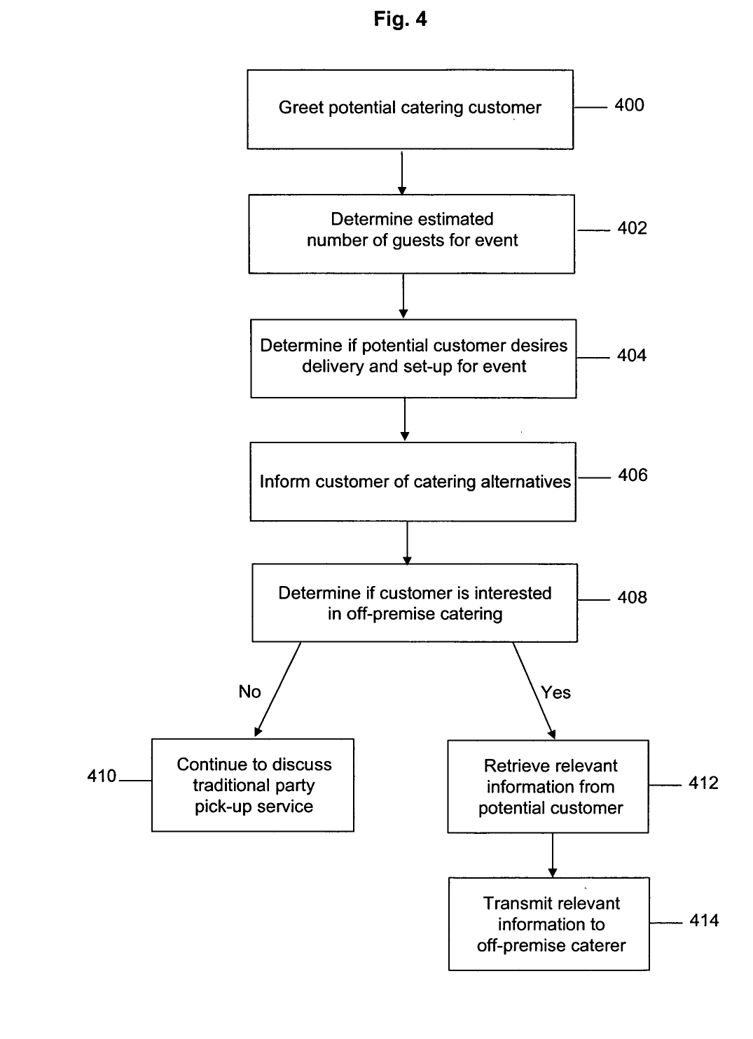

FIG. 4 is a flow diagram illustrating a method of determining if off-premise catering is appropriate for an event, in an embodiment of the present invention where an employee of supermarket 100 (e.g., a catering coordinator) is stationed at location 112. At step 400, the catering coordinator greets the customer (or potential customer). At step 402, the catering coordinator determines the estimated number of guests for the event. At step 404, the catering coordinator determines if the customer desires delivery and set-up of food items for the event. In addition to the information received by the catering coordinator at steps 402 and 404 (i.e., estimated number of guests, delivery/set-up information), additional information may be received by the catering coordinator to help the catering coordinator determine if off-premise catering is appropriate for the event.

At step 406, the catering coordinator informs the customer of catering alternatives that the customer may utilize in connection with supermarket 100. For example, such alternatives include picking up traditional party trays (e.g., deli trays, cheese trays, etc.) or utilizing an off-premise caterer that is associated with supermarket 100. For example, the customer may desire to utilize the off-premise caterer if the customer desires assistance with food delivery, food set-up, food service, equipment supply, equipment set-up, etc.

At step 408, based on information provided by the customer, the catering coordinator determines if the customer is interested in off-premise catering. If the customer is not interested in off-premise catering, the process proceeds to step 410, where the catering coordinator continues to discuss traditional party pick-up service with the customer.

If the catering coordinator determines that the customer is interested in off-premise catering (and/or if off-premise catering is appropriate for the event), the process proceeds to step 412. At step 412, the catering coordinator retrieves additional relevant information from the customer. For example, such relevant information may include information useful by the off-premise caterer such as customer contact information, general event information, etc. At step 414, the catering coordinator transmits the information to the off-premise caterer associated with supermarket 100. For example, such information may be transmitted by fax, e-mail, and any of a number of alternative techniques of information transmission.

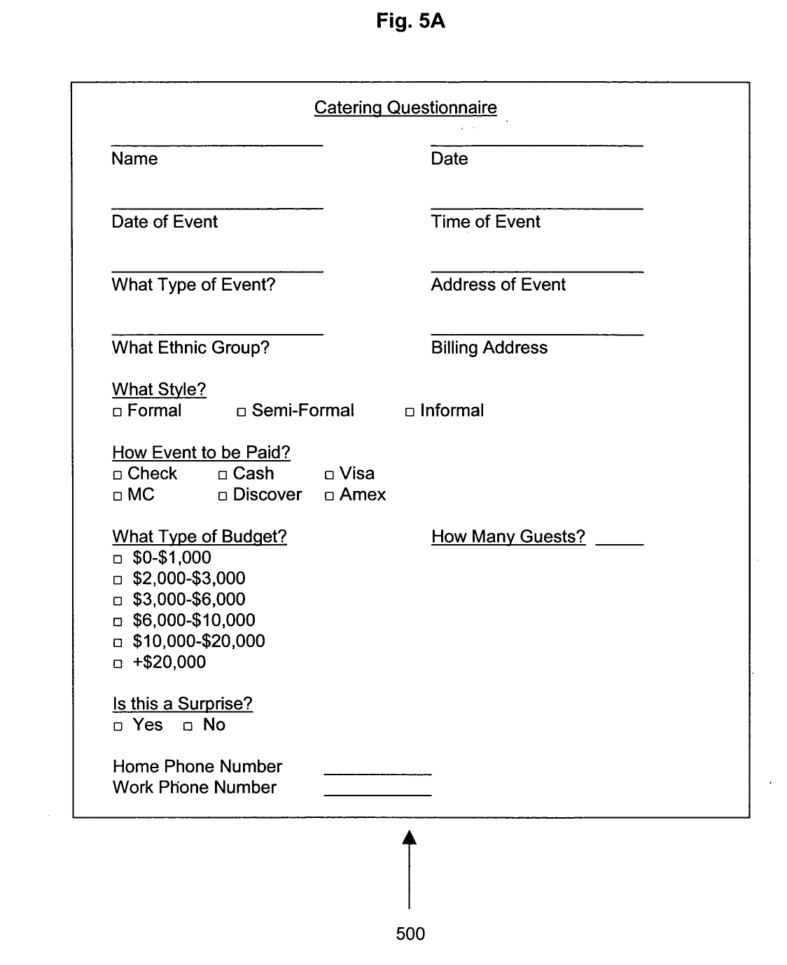

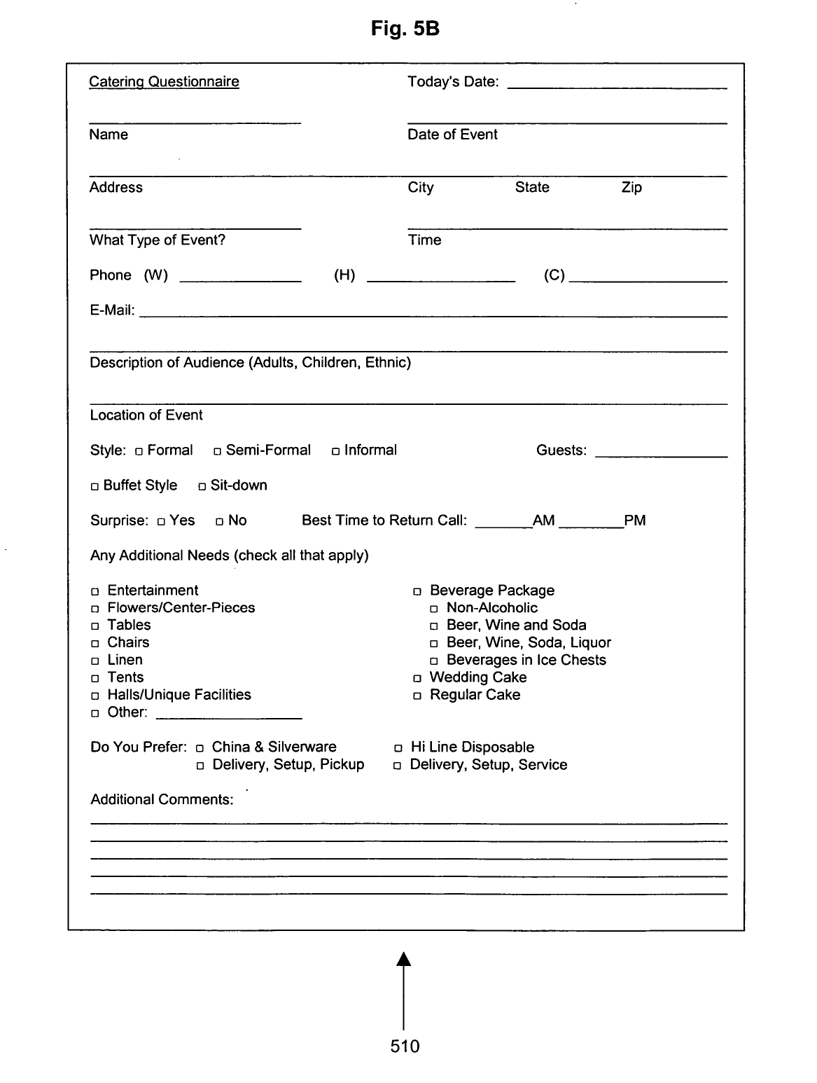

FIGS. 5A and 5B illustrate exemplary catering questionnaires 500 and 510 that may be used by the catering coordinator in order to tabulate the information to be sent to the off-premise caterer. For example, these forms may be filled out by the catering coordinator (in conjunction with the customer) or by the customer directly. Further, such forms may be in paper form, or filled out electronically. Further still, such forms may be completed after it is determined that off-premise catering is appropriate for an event, or as part of a process of determining if off-premise catering is appropriate for the event.

Referring specifically to FIG. 5A, catering questionnaire 500 includes information such as customer contact information (e.g., name, billing address, home and work telephone numbers, etc.), event information (e.g., date of event, type of event, time of event, address of event, primary ethnic group of event, style of event, etc.), payment method, budget of event, and the estimated number of guests.

Likewise, catering questionnaire 510 illustrated in FIG. 5B includes customer contact information and event information. Further, catering questionnaire 510 includes additional details related to the event such as whether the main meal will be buffet or sit-down, whether the event is a surprise event, the best time to contact the customer, etc. Of course, catering questionnaires 500 and 510 are exemplary in nature, and various alterations may be made to them.

After receiving the transmission of information from supermarket 100 (e.g., in the form of a completed catering questionnaire), the off-premise caterer contacts the potential customer. Because of the receipt of the catering questionnaire, the caterer is more knowledgeable regarding the customer and the event.

The off-premise caterer makes this contact with the potential customer in an attempt to complete the sale of off-premise catering services. During this contact, the off-premise caterer may obtain additional information related to the event. Such information includes, for example, food selections for the event (including prepared food items sold by the supermarket), and details regarding the services desired by the potential customer. This information will assist the caterer in determining the costs of the event.

By serving food items (e.g., prepared food items) provided by the supermarket, a number of benefits are achieved. For example, the customer (who may be familiar with certain prepared food items sold by the supermarket) may select food items with which the customer is familiar. Further, the supermarket achieves additional sales of prepared food items that the supermarket otherwise would not achieve because of the supermarket's lack of capabilities related to off-premise catering. Further still, the off-premise caterer is benefited in that the caterer does not need to prepare the food items. Rather, the off-premise caterer simply picks up the prepared food items from the supermarket (e.g., on the day of the event) and supplies the food items to the customer.

After determining the relevant information related to the event, the off-premise caterer is able to offer a catering package to the customer. For example, the catering package includes a menu for the event as well as a price for the catering package. If the customer agrees with the catering package offered by the off-premise caterer, the off-premise caterer then communicates to the supermarket the food items to be supplied by the supermarket.

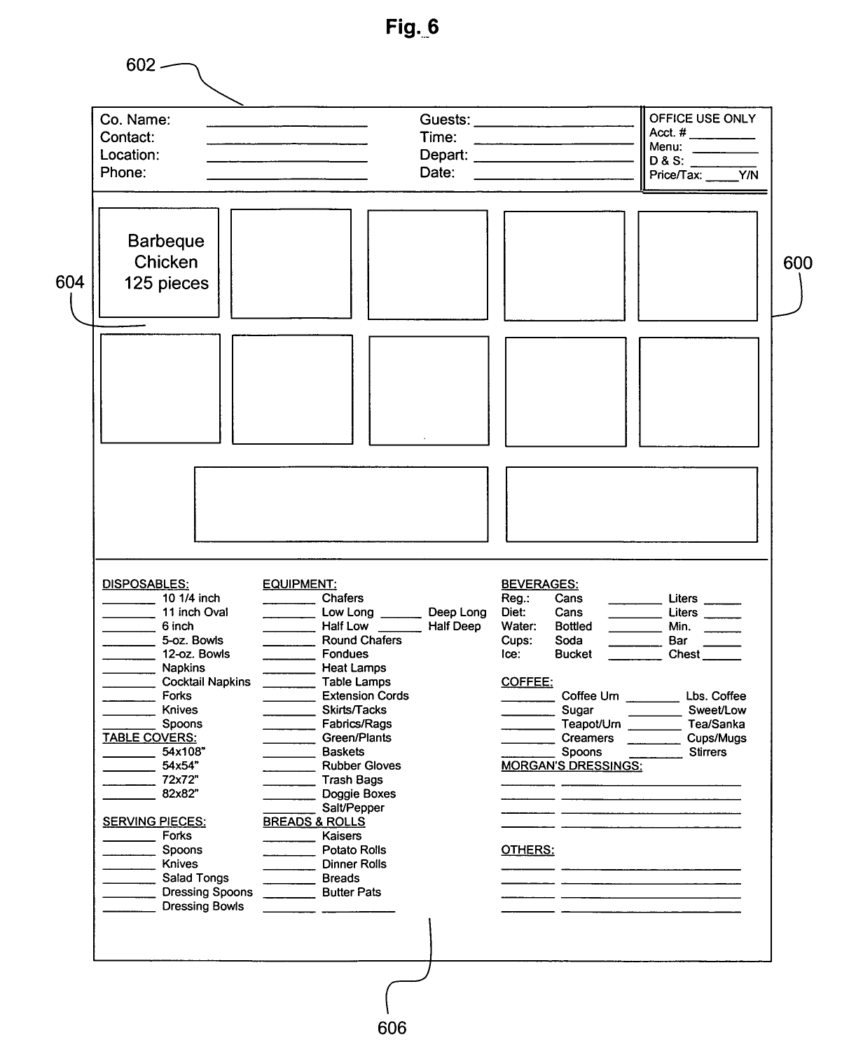

For example, FIG. 6 illustrates form 600 used to list the items to be used for an event. Section 602 of form 600 includes administrative information related to the event, such as customer contact information, date of event, time of event, etc. Section 604 of form 600 includes a number of blocks. Each of these blocks may be used to list a food item to be supplied by the supermarket. For example, in a given block, the off-premise caterer may list the type of food item to be used and the quantity of food item to be used. As illustrated in FIG. 6, the upper left block in section 604 indicates that prepared barbeque chicken is to be supplied by the supermarket, and that the quantity of barbeque chicken to be supplied by the supermarket is 125 pieces. Through the use of the blocks in section 604, the supermarket (that will be providing the prepared food items) is given a clear and predictable indication of prepared food items to provide, with quantities listed.

Section 606 of form 600 lists a number of items that may or may not be used during an event. These items (e.g., disposal items, table covers, serving pieces, equipment, breads and rolls, beverages, coffees, salad dressings, and other food related items) may be supplied by the off-premise caterer. Alternatively, such items may also be provided by the supermarket.

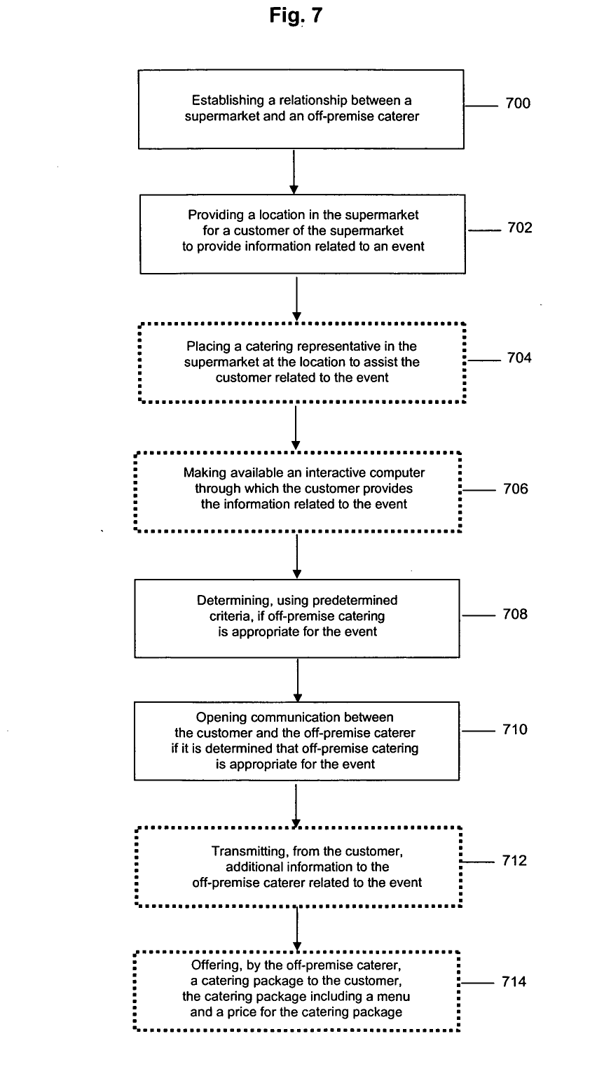

FIG. 7 is a flow diagram illustrating a method of promoting an off-premise catering business. At step 700, a relationship is established between a supermarket and an off-premise caterer. For example, the supermarket and the off-premise caterer may be located in the same geographic area, thereby providing a number of benefits. For example, a benefit is provided in that the off-premise caterer is familiar with event locations (e.g., catering facilities) in the same geographic area as the supermarket, thereby benefiting the customers of an off-premise event. According to the relationship established at step 700, the supermarket provides at least a portion of the foodstuff items used by the off-premise caterer for an event when the off-premise caterer receives the event through the established relationship. Further, according to the relationship established at step 700, the supermarket may advertise the services of the off-premise caterer. For example, such advertising may be accomplished through signs posted within the supermarket, through circulars mailed to addresses within the same geographic area as the supermarket, through radio/television/Internet advertising, through papers provided to customers at checkout, through targeted or mass e-mail advertising, etc. Further still, according to the relationship established at step 700, the off-premise caterer may bear the responsibility of negotiating off-premise catering contracts with customers of the supermarket.

At step 702, a location is provided in the supermarket for a customer of the supermarket to provide information related to the event. Such a location may include, for example, a catering desk (e.g., catering desk 200 illustrated in FIG. 2) and/or a catering kiosk (e.g., catering kiosk 300 illustrated in FIG. 3).

At optional step 704, a catering representative (e.g., a catering coordinator) is placed in the supermarket at the location to assist a customer related to the event. At optional step 706, an interactive computer (e.g., a touch screen computer) is made available at the location through which the customer provides information related to the event.

At step 708, using predetermined criteria, a determination is made as to whether off-premise catering is appropriate for the event. For example, the predetermined criteria may relate to the number of guests estimated to attend the event. Further, the predetermined criteria may relate to whether the customer desires assistance with certain catering services (e.g., delivery services, food set-up, equipment set-up, serving assistance, etc.) from an off-premise caterer. At step 710, communication is opened between the customer and the off-premise caterer if it is determined (at step 708) that off-premise catering is appropriate for the event. At step 712, additional information is transmitted from the customer to the off-premise caterer related to the event. For example, such additional information may include menu choices, desired catering services, etc. At optional step 714, a catering package is offered by the off-premise caterer to the customer, where the catering package includes a menu and a price for the catering package.

According to certain exemplary embodiments of the present invention, methods of establishing a relationship between a supermarket and an off-premise caterer are provided. According to such embodiments, a third party that is familiar with off-premise catering may establish such a relationship between the supermarket and the off-premise caterer.

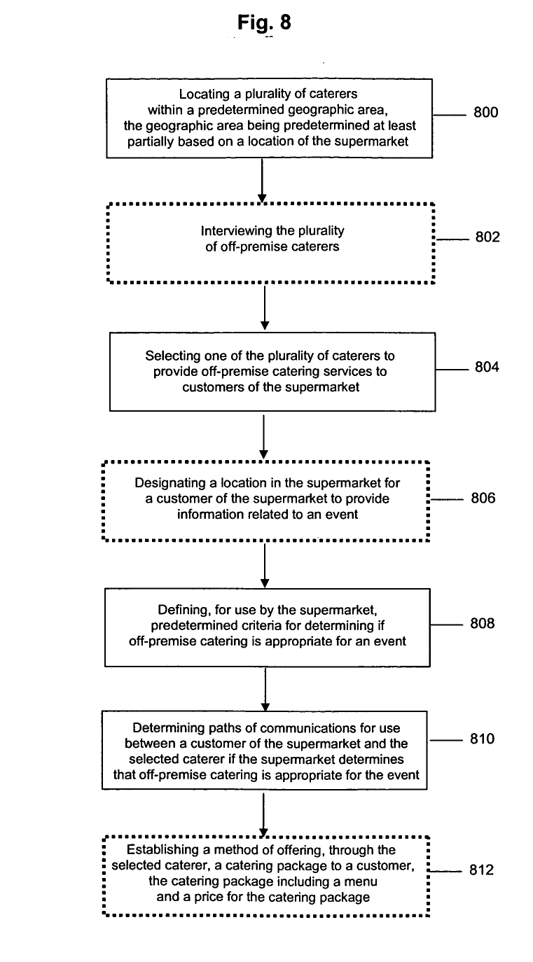

FIG. 8 is a flow diagram illustrating such a method of establishing a relationship between a supermarket and an off-premise caterer. At step 800, a plurality of caterers are located within a predetermined geographic area, where the geographic area is predetermined at least partially based on a location of the supermarket. At optional step 802, the plurality of off-premise caterers are interviewed, for example, by the third party described above. At step 804, one of the plurality of caterers is selected to provide off-premise catering services to customers of the supermarket. At optional step 806, a location in the supermarket is designated where a customer may provide information related to the event. For example, the location may be defined to include a computer (e.g., a touch screen computer) through which the customer may provide the information related to the event. Alternatively, the location may be defined to include a catering representative to assist a customer in providing the information related to the event. Further still, according to certain exemplary embodiments of the present invention, both a computer and a catering representative may be provided at the location. For example, if the catering representative is busy with another customer, or if the catering representative is off-duty (e.g., in the evening, in the early morning, at lunchtime, during weekends, etc.), a customer may still use the interactive computer to enter the desired information.

At step 808, predetermined criteria, for use by the supermarket, are defined for determining if off-premise catering is appropriate for an event. For example, such predetermined criteria may relate to the number of guests estimated to attend the event, or catering services desired by the customer at the event. At step 810, communication paths are determined for use between a customer of the supermarket and the caterer selected at step 804 if the supermarket determines that off-premise catering is appropriate for the event. At optional step 812, a method of offering a catering package to a customer (through the selected caterer) is established, where the catering package includes a menu and a price for the catering package.

According to certain exemplary embodiments of the present invention, a large portion of the transactional activity between the parties (e.g., the customer, the supermarket, and the off-premise caterer) may be conducted via computers, for example, via the Internet and an automated message delivery system.

For example, a customer may enter the supermarket and enter information into a computer kiosk, such as catering kiosk 300 illustrated in FIG. 3. Alternatively, the customer may log onto the website of the supermarket and enter the information into the website as if the customer were at the computer kiosk.

A computer algorithm may automatically determine, based on the information input by the customer, if off-premise catering is appropriate for the events (e.g., based on event size and service needs). If the algorithm determines that off-premise catering is appropriate for the event, an e-mail (including certain information provided by the customer) may automatically be sent (e.g., by a computer associated with the supermarket) to the off-premise caterer associated with the supermarket.

After receiving such a message (which may or may not be copied to the supermarket), the off-premise caterer contacts the customer in an attempt to “sell” a catering package to the customer. According to the present invention, this contact may be in-person, via telephone, via facsimile, via e-mail, via a combination thereof, or by any other appropriate means. After a catering package is “sold” to the customer by the off-premise caterer, the off-premise caterer sends the supermarket an e-mail indicating the foodstuff items (e.g., the prepared foods) to be provided by the supermarket for the event. Such an e-mail could replace section 604 of form 600 illustrated in FIG. 6. Through such a message, the supermarket has knowledge of the type and quantity of foodstuff items to be provided for the event. Further, the e-mail from the off-premise caterer to the supermarket may be sent directly to a system (in a computer/machine readable format) that tracks the quantities of foodstuff items required by the supermarket. Through this example, it is clear that the methods disclosed herein (or any portion thereof) may be automated or improved by use of computer systems and the like.

As described herein, the present invention provides substantial benefits to both the supermarket and the off-premise caterer. With respect to the supermarket, additional revenue is generated by selling prepared food items for use in an off-premise catered event. Normally, such revenue is not generated because supermarkets typically do not have the catering expertise/knowledge base, equipment, and staff to support an off-premise catering business.

Additionally, the off-premise caterer is benefited in that many potential customers (i.e., the customers of the supermarket and their associates) are exposed to the services of the off-premise caterer. In contrast to conventional off-premise catering practices (in which the caterer often prepares certain food items, particularly entrees), according to the present invention, at least a portion of the foodstuff items (e.g., prepared food items) are provided by the supermarket. The price paid by the off-premise caterer to the supermarket for certain prepared food items may exceed that which the off-premise caterer would pay for similar items if the caterer prepared such food items. Thus, it may appear that this relationship is somewhat less beneficial to the off-premise caterer when compared to traditional off-premise catering practices; however, this is typically not the case. Initially, the off-premise caterer receives sales that he/she would likely otherwise not receive through the supermarket. Further, because the off-premise caterer does not prepare certain food items provided by the supermarket, there is a reduced cost to the caterer related to food preparation expenses (e.g., cooking staff, energy and clean-up costs, etc.). Further still, the off-premise caterer is able to handle an increased customer volume (due to off-premise catering orders placed by customers of the supermarket), without a corresponding increase in certain expenses (e.g., staffing, food preparation space, food storage space, etc.).

Additionally, customers of both the supermarket and the off-premise caterer are substantially benefited by the present invention. For example, in contrast to traditional off-premise catering, the customer is able to select certain food items with which the customer is familiar. The customer is at least somewhat familiar with the price of such items (because of the familiarity with the items obtained by shopping in the supermarket). Further, the customer is able to hire an off-premise caterer for only the services desired by the customer.

Although the present invention has primarily been described in connection with a single off-premise caterer for a given supermarket, it is not limited thereto. Thus, any desired number of off-premise caterers may be used in connection with a supermarket.

Although the invention is illustrated and described above with reference to specific embodiments, the invention is not intended to be limited to the details shown. Rather, various modifications may be made in the details within the scope and range of equivalents of the claims and without departing from the invention.

1. A method of promoting an off-premise catering business comprising the steps of:
establishing a relationship between a supermarket and an off-premise caterer;
providing a location in the supermarket for a customer of the supermarket to provide information related to an event;
determining, using predetermined criteria, if off-premise catering is appropriate for the event; and
opening communication between the customer and the off-premise caterer if it is determined that off-premise catering is appropriate for the event.

2. The method of claim 1 wherein the step of establishing includes establishing a relationship between a supermarket and an off-premise caterer in the same geographic region.

3. The method of claim 1 wherein the step of establishing includes establishing a relationship between a supermarket and an off-premise caterer wherein the supermarket provides a substantial portion of the foodstuff items used by the off-premise caterer for an event when the off-premise caterer receives the event through the relationship.

4. The method of claim 1 wherein the step of establishing includes establishing a relationship between a supermarket and an off-premise caterer wherein the supermarket advertises the services of the off-premise caterer in connection with foodstuff items provided by the supermarket.

5. The method of claim 1 wherein the step of establishing includes establishing a relationship between a supermarket and an off-premise caterer wherein the off-premise caterer negotiates off-premise catering contracts with customers of the supermarket.

6. The method of claim 1 wherein the step of establishing includes establishing a relationship between a supermarket and an off-premise caterer wherein the off-premise caterer provides off-premise catering services to customers of the supermarket.

7. The method of claim 1 further comprising the step of:
placing a catering representative in the supermarket at the location to assist the customer related to the event.

8. The method of claim 1 further comprising the step of:
making available an interactive computer through which the customer provides the information related to the event.

9. The method of claim 1 wherein the step of determining includes determining if off-premise catering is appropriate for a number of guests for the event estimated by the customer.

10. The method of claim 1 wherein the step of determining includes determining if off-premise catering is appropriate for the catering services desired by the customer.

11. The method of claim 1 further comprising the steps of:
transmitting, from the customer, additional information to the off-premise caterer related to the event; and
offering, by the off-premise caterer, a catering package to the customer, the catering package including a menu and a price for the catering package.

12. A method of establishing a relationship between a supermarket and an off-premise caterer comprising the steps of:
locating a plurality of caterers within a predetermined geographic area, the geographic area being predetermined at least partially based on a location of the supermarket;
selecting one of the plurality of caterers to provide off-premise catering services to customers of the supermarket;
defining, for use by the supermarket, predetermined criteria for determining if off-premise catering is appropriate for an event; and
determining paths of communications for use between a customer of the supermarket and the selected caterer if the supermarket determines that off-premise catering is appropriate for the event.

13. The method of claim 12 further comprising the step of:
designating a location in the supermarket for a customer of the supermarket to provide information related to an event.

14. The method of claim 13 wherein the step of designating a location includes defining a location in the supermarket including a computer for a customer of the supermarket to provide information related to an event.

15. The method of claim 13 wherein the step of designating a location includes designating a location in the supermarket including a catering representative in the supermarket at the location to assist the customer related to the event.

16. The method of claim 12 further comprising the step of:
interviewing the plurality of off-premise caterers.

17. The method of claim 12 wherein the step of defining predetermined criteria includes defining a minimum number of guests for an event that is appropriate for off-premise catering.

18. The method of claim 12 wherein the step of defining predetermined criteria includes defining catering services that, if desired by a customer, are appropriate for off-premise catering.

19. The method of claim 12 further comprising the step of:
establishing a method of offering, through the selected caterer, a catering package to a customer, the catering package including a menu and a price for the catering package.
